(19) United States
(12) Patent Application Publication
(10) Pub. No.: US 2020/0191551 A1
(43) Pub. Date: Jun. 18, 2020

(54) DEVICE FOR MEASURING THE PARAMETERS OF PHASE ELEMENTS AND OPTICAL FIBER DISPERSION AND A METHOD OF MEASURING THE PARAMETERS OF PHASE ELEMENTS AND OPTICAL FIBER DISPERSION

(71) Applicant: POLSKIE CENTRUM FOTONIKI I SWIATLOWODÓW, Glogów (PL)

(72) Inventors: Karol STEPIEÑ, Warszawa (PL); Michalina JÔZYIK, Augustow (PL); Marek NAPIERALA, Warszawa (PL); Anna ZIOLOWICZ, Kielce (PL); Lukasz SZOSTKIEWICZ, Torun (PL); Michal MURAWSKI, Warszawa (PL); Stanislaw LIPIÑSKI, Ilowo (PL); Zbigniew HOLDYÑSKI, Warszawa (PL); Tomasz STAÑCZYK, Piaseczno (PL); Tomasz NASILOWSKI, Warszawa (PL)

(21) Appl. No.: 15/761,421

(22) PCT Filed: Nov. 30, 2015
(86) PCT No.: PCT/PL2015/050065

§ 371 Date: Mar. 19, 2018

(30) Foreign Application Priority Data
Sep. 18, 2015 (PL) P.414064

(51) Int. Cl. G01B 9/02; G01B 11/06; G01M 11/02; G01N 21/45

(52) U.S. Cl. CPC G01B 9/02024; G01B 9/0209; G01N 21/45; G01B 11/06; G01M 11/0271; G01B 9/02072

(57) ABSTRACT

A device for measuring the parameters of phase elements and dispersion of optical fibers, characterized in that it contains: a light source, serially connected to fiber optic coupler, one of whose arms constitutes a part of the reference arm, and whose second arm constitutes a part of the measurement arm of the device, and a motorized linear stage is mounted on the arm of the device. One of the arms of the device is connected to at least one detector, and at least one collimator is placed in at least of the arms of the device, at least before the phase element. A method of measuring the parameters of the phase element and the dispersion of optical fibers is conducted in two stages, wherein the first stage assumes the calibration of the device and the second stage is the proper measurement.

The subject of the invention is a device for measuring the parameters of phase elements and optical fiber dispersion and a method for measuring the parameters of phase elements and optical fiber dispersion. The parameters of phase elements, including, but not limited to lenses, are inter alia the refractive index and thickness. The device and the method applies white light interference (low-coherence interference). The device and the method are also applied in dispersion measurements, in particular to measure the dispersion of dispersion compensating optical fibers, i.e. optical fibers characterized by considerably higher (absolute) dispersion values, compared to standard optical fibers used in telecommunication.

Technical practice defines several methods of measuring the parameters of phase elements, including their refractive indexes and thickness, applying various physical phenomena and effects. The following contact techniques are known: measurements with the use of indicators, measurements with the use of coordinate-measuring machines (CMM), which, by collecting a cloud of points, generates information on the profile of a phase element, including its thickness, as well as the simplest caliper measurements. The contact methods known include: interferometric, ellipsometric, and ATR-based (attenuated total reflection and internal reflection) methods (attenuated total reflection infrared spectroscopy).

One of the challenges in the measurement of phase element parameters is to perform maximally precise measurements of the phase element parameters without touching their surface with the mechanical parts of the measurement setup. Contact methods can result in damage, particularly mechanical, of the tested element and its surface, and require precise assembly of both the phase element and the measurement unit, which is very difficult in industrial conditions. What is more, the familiar contact methods are not dedicated to measurements of concave lenses with a big radius of curvature except for laboratory measurements, and the possible cost of purchase of precise instrumentation often exceeds the value of an entire production line.

Article titled “Measurement of the refractive index and thickness for lens by confocal technique” by Yun Wang, Lirong Qiu, Jiamiao Yang and Weiqian Zhao (Optik—International Journal for Light and Electron Optics, 2013) describes a method of determining the refractive index or the thickness of a phase element in a confocal system. The technique applies the ray tracing method. After passing through a lens, a beam of light is focused in a central point of the first tested surface of the phase element, and then redirected to a mirror. The lens is shifted in reference to the tested surface of the phase element. The value of the focus curve peak is tested according to changing positions of the phase element in reference to the focal distance of the lens. After being directed to the detector, the signal is processed by a calculation algorithm. Before performing the measurement, the system is aligned, and the accuracy of alignment determines the precision of measurement. Signal is entered to the measurement system by a beam splitter cube. The application of bulk optics (in this case, the beam splitter cube) increases the risk of de-aligning the system due to the possibility of dusting or moving the element.

A ray tracing method has been also described by the authors of the publication titled “Laser differential confocal lens thickness measurement” by Yun Wang, Lirong Qiu, Yanxing Song and Weiqian Zhao (Measurement Science and Technology, 2012), where the authors apply a confocal system. In contrast to the former article, this method assumes system modification consisting in the application of differential measurement, which entails the use of a second detector. Such measurements are more precise on the one hand, but, on the other hand, require extended measurement duration and calculation powers.

Article titled “Low coherence interferometry for central thickness measurement of rigid and soft contact lenses” by Verrier I., Veillas C., and Lépine T. (Optics Express, 2009) describes a method of measuring the thickness of contact lenses with the use of low-coherence light sources. In this method, a light beam is directed to a system consisting of two interferometers: a Mach-Zehnder interferometer and a SISAM correlator system, an acronym of two words: “interferential spectrometer by selection of amplitude modulation”, which consists of two diffraction gratings, a beam splitter, lenses and a CCD camera for signal detection. An essential advantage of this method is that it is contact-less, but requires the application of complex mathematical algorithms to eliminate the dispersion effect. The system is characterized by the use of a set of elements and mirrors, whereas a larger number of elements calls for the need to apply a source with higher output power. In essence, increasing the number of elements in the system raises the cost and the risk of shifts which have negative effect on maintaining the beam on the default track. The accuracy of the system is also determined by the resolution of the camera applied.

Other familiar measurement techniques combine white light interferometry (low-coherence interferometry) with confocal measurement techniques, as described in detail in article titled “Simultaneous measurement of refractive index and thickness by combining low-coherence interferometry and confocal optics” by Seokhan Kim, Jihoon Na, Myoung Jin Kim, and Byeong Ha Lee (Optics Express, 2008). In this method, beam splitting for interferometry is performed in the beam splitter cube. Measurements of the refractive index and thickness of lenses require the application of two systems.

Patent ref. U.S. Pat. No. 7,433,027 describes a device and non-contact method of measuring lens thickness (in particular of corrective lenses for glasses) applying volumetric optics. The operation principle of the system is based on data collection by means of an imaging system comprising a camera with a CCD matrix. After completing the measurement, the phase element must be turned by a dedicated handle. Using image processing methods, it is possible to obtain a 3D image of the measured phase element.

Patent application ref. 20070002331 A1 describes a method of measuring molds/lenses during production. The method is based on the use of interferometer measurements applying volumetric optics.

Patent application ref. US 20130278756 A1 presents a device and a method of measuring the thickness of transparent element by shifting the focal distance of the passing beam, then the thickness is determined according to Snell's law. The device comprises a camera focusing light on the surface of the measured object. This method can be used to achieve high accuracy. The method is not dedicated to measuring lenses, in which optical power occurs, since its presence causes a speck shift, and thus the possibility of measurement distortion.

Patent application ref. US 20140253907 A1 contains a description of measurement of the central thickness of a phase element, applying white light interference and coherent light interference. Change of optical distance is performed with the use of piezoelectric elements. Furthermore, the method applies the measurement of passing light wavefront applying a Shack-Hartmanm sensor. Other parameters of the phase element are calculated on the basis of the wavefront, such as the focal distance. Implementation of this measurement method requires the use of three light sources. The device applies optical fibers, which are wound on a piezoelectric used to change the optical path between the interferometer arms.

Technical practice defines the problem of measuring the dispersion of phase velocity (hereinafter: dispersion), in particularly of optical fibers. Measurement of this parameter is key for the development of techniques compensating peak expansion in telecommunication lines. The more compensating a fiber is (the higher its dispersion in absolute terms), the smaller the length which is to be established on the telecommunication line in order to recreate the input signal.

An example of a system for measuring the dispersion of optical fibers is described i. a. in article titled “Experimental study of dispersion characteristics for a series of microstructured fibers for customized supercontinuum generation” by Z. Holdynski et. al. (Optics Express 2013). In this method, thanks to the application of white light interferometry in the configuration of Michelson's interferometer, it is possible to obtain high accuracy, however, measuring range is limited due to the occurrence of a relatively small difference in the value of chromatic dispersion between the measured optical fiber and a reference optical fiber (in the case of this method, it is e.g. standard single-mode optical fiber, e.g. SMF-28 by Corning). Effectively means that dispersion larger than minus several dozen ps/(nm·km) cannot be measured. Due to negative dispersion in dispersion compensating optical fibers, wherever the phrase “higher dispersion” occurs in the patent, this stands for an absolutely higher value. For instance, dispersion of (−100) ps/(nm·km) is larger than dispersion of (−18) ps/(nm·km).

Other methods of measuring optical fiber dispersion base i. a. on the direct application of the definition of dispersion, that is the measurement of the pulse broadening with specified distance or the measurement of time delay as a function of the wavelength. Using such measurement methods, optical fibers with small dispersions enforce large parts of optical fiber. In turn, in the case of optical fibers with large dispersions, in the case of peak broadening is observed at a small distance, a problem occurs with the attenuation properties of these optical fibers. Such optical fibers are usually fabricated out of soft glass, due to which they have loss of several dB/m. In result, signal can be measured with the use of small parts of the fiber, and when applying sections of several dozen cm, assembly of the optical fiber section in the measurement system is difficult, or even impossible. Shortening too much the measured optical fiber has negative effect on the ability to observe peak broadening.

Patent ref. U.S. Pat. No. 4,799,789 A describes a method of measuring group velocity dispersion. The measurement method takes advantage of the fact that each wavelength has a different propagation time in a given dispersion medium, and measurement consists in the measurement of the time of propagation of light through the measured and the reference optical fibers. A cascade of diode lasers is applied as the source of light (or LED diodes, depending on the configuration) with varying length of the generated wave, thanks to which it is possible to change the wavelength in both optical fibers. By scanning the propagation time of the beam as a spectrum function, we obtain group velocity dispersion.

Patent application ref. WO 2006118911 describes a measurement of longitudinal dispersion (as the distance function), which is performed with the use of this dispersion measurement method as the wavelength function. The method is dedicated to the measurement of traditional telecommunication fibers, in which the length of the optical fiber is not limited due to losses.

Therefore, the purpose of works on the invention was to develop a system, which would ensure the possibility of performing industrial measurements of the parameters of phase elements (e.g. the refractive index and thickness). One of the industrial requirements as part of quality control of the manufactured phase elements is i. a. control of their thickness. The majority of familiar systems reach very good parameters in this area—there is a possibility of performing measurements with the accuracy of several μm, or even μm parts. Insofar as the accuracy of such measurements is relatively satisfactory, the structures of measurement systems are not compact, and their operation enforces laboratory use only. Another hindrance posed by such systems is the need to provide highly qualified operation personnel. These problems are eliminated by the device according to the invention, which guarantees non-contact, non-destructive measurements which, apart from increasing measurement accuracy to below 1 μm, allow for performing compact and comfortable control measurements in uncomfortable industrial conditions. In order for the invention to fulfill the expectations posed for automatic measurements, elements of volumetric optics were resigned from wherever possible, which allows for direct assembly on the production line. For instance, solutions deriving from technical practice assume beam division predominantly in the beam splitter cube. Such beam division poses a risk of considerable measurement errors or generally the impossibility to perform measurements due to close correlation of beam splitting and temperature and mechanic conditions. In the solution according to the invention, this problem is solved by the application of beam splitting using fiber optic couplers. In such configuration, the element cannot be dusted and the temperature and vibrations do affect beam splitting at an insignificant level (moving the fiber optic coupler also remains without effect on the effectiveness of beam splitting, whereas such movement would prevent measurement when a cube is used). Furthermore, fiber optic elements are usually less expensive to their volumetric optics counterparts. The system according to the invention does not include CCD cameras, the use of which always induces uncertainty deriving from the possibility of losing a part of the information when the beam does not hit the matrix. In the solution according to the invention, the receiving fiber optic connector is fixed inside the head unit for the entire duration of measurement. When applying a low-coherence light source, dispersion of the measured element has effect on the measurement result. Thanks to the application of this measurement principle, it is possible to adopt the system in automatic measurements, whereas the cost of construction of the system is considerable lower compared to the examples quoted in the patent.

Furthermore, the purpose of the invention was to develop a device for measuring the dispersion of phase velocity of optical fibers, in particular of dispersion compensating optical fibers, which is highly desired in telecommunications applications. In a beneficial embodiment of the invention, it is possible to measure phase velocity dispersion for dispersion compensating optical fibers. A part of the systems used for measuring phase dispersion, familiar from technical practice (particularly those applying interferometer methods), cannot be used for optical fibers indicating dispersion (absolute) exceeding several dozen ps/(nm·km). When applying the system according to the invention, it is possible to conduct unlimited measurements even for extremely high absolute dispersion values.

The device for measuring the parameters of phase elements and dispersion of optical fibers contains: at least one, preferably low-coherence light source, serially connected to at least one fiber optic coupler, one of whose arms constitutes a part of the reference arm, and whose second arm constitutes a part of the measurement arm of the device, and at least one motorized linear stagemotorized linear stage is mounted on at least one arm of the device, and at least one of the arms of the device is connected, either directly, or through an additional fiber optic coupler, to at least one detector, preferably a photodiode, and at least one collimator is placed in at least of the arms of the device, at least before the phase element. During measurement, the device specifies the parameters of the phase element, preferably with the use of an additional, model phase element.

Whereas the measured element is construed particularly as a measured lens construed as a lens subjected to measurement to define its parameters.

The measurement arm of the device according to the invention, in its beneficial embodiment, contains: optical fiber comprising the input couplet, a collimator located in the end of the optical fiber comprising the input coupler, free space, in which the phase element, preferably a lens, is located and mounted in a handle for the duration of measurement, a collimator located in the beginning of optical fiber comprising the output fiber optic coupler, and optical fiber comprising the output fiber optic coupler.

The reference arm of the device according to the invention, in its beneficial embodiment, contains: optical fiber comprising the input coupler, free space, a collimator located in the beginning of optical fiber comprising the output coupler, whereas one of the collimators is mounted on a motorized linear stage.

The length of the arms of the device according to the invention is divided into length in optical fibers and free space length.

At least one light source is connected to the input coupler, whose optical fibers comprising the measurement and reference arms are terminated with collimators, one of which is connected to a motorized linear stage, and a fiber optic coupler terminated with a detector is connected to the reference and measurement arm on the other side. At the stage of conducting measurement, a phase element is mounted in the measuring optical fiber area. In a beneficial embodiment, the phase element is at least one lens mounted on the motorized linear stage.

In a beneficial embodiment, a model phase element—preferably a model lens of predefined thickness is placed on the reference arm.

In another embodiment, the measured phase element, in particular the measured lens, is placed in the free space of the measurement arm, right after the collimator, which is placed in the terminal of the optical fiber comprising the input coupler, and before the collimator supporting themotorized linear stage. The optical fiber comprising the input coupler, which is not terminated with a collimator, is connected directly to the optical fiber comprising the output coupler, which is also not terminated with a collimator.

In addition, it is possible for the collimator supporting the motorized linear stage to be placed on another arm, than the measuring phase element, in particular the measured lens.

In a beneficial embodiment, a second, coherent light source is applied apart from the low-coherence light source. The coherence path of the second coherent light source is at least equal to the range of motion of the motorized linear stage. In such case, the coherent and low-coherence light sources are cross-connected to the device, and the output signal from the low-coherence light source is directed through the input fiber optic coupler to the reference and measurement arm, and then reaches the detector through the connected output coupler. The coherent light source is connected to the second optical fiber comprising the output coupler. From the light source, signal is directed through the output fiber optic coupler and the measurement and reference arms to the input fiber optic coupler and the second detector.

In a beneficial embodiment, the low-coherence light source is a light source selected from among SLED, LED, supercontinuum light sources, low-coherence lasers and other, in which the spectral width is at least several nanometers.

In a beneficial embodiment, the motorized linear stage is movable, moving along at least one axis. In a beneficial embodiment, the handle of the phase element is movable moving along three axes and enables rotation around any of these axes.

The optical fibers comprising the fiber optic couplers are terminated with collimators.

In a different embodiment, the device according to the invention is preferably assembled according to the reflective configuration.

In a beneficial embodiment, the method of measuring the parameters of the phase element and the dispersion of optical fibers applying the device according to the invention is two-staged, wherein the first stage assumes calibration (reference measurement) of the device according to the invention, and the second stage is the proper measurement. Whereas, with reflective configuration, the calibration measurement and the proper measurement are performed during one scanning.

During the calibration of the device according to the invention, the light from the low-coherence light source is directed to the fiber optic coupler, where it is separated into two arms: measurement and reference.

Further on, the motorized linear stage slides, recording information on its position, until it obtains zero difference in optical paths, which is read using the detector and analyzed by an interferogram. Interference occurs in the fiber optic coupler after passing through the collimators, and the interferogram is collected as the time function, which translates into motorized linear stage movement. The interferogram is collected by the photodetector, in particular by the photodiode.

When using an additional, coherent light source, calibration measurement is identical to the above specified. The interferogram collected from the additional source (coherent) aims at increasing the precision of measurement by accurately establishing the wavelength difference between the arms (as resulting from the difference of optical paths).

After the device is calibrated, the system proceeds to proper measurement, in which a phase element, particularly a lens intended for measurement, is inserted in the measurement arm of the device according to the invention, between the collimators. Further on, sliding the motorized linear stage, the position producing zero optical path difference is determined. Basing on differential positions of the motorized linear stage for interferogram contrast maximums in the calibration measurement and in the proper measurement with the phase element, and having the refractive index for glass, from which the phase element was made, the thickness of the phase element is determined (we are familiar with the optical path difference introduced by the phase element).

Whereas, in a beneficial embodiment, during proper measurement, a phase element with known parameters is placed in the reference arm. If it is a model lens, we then have familiar thickness, curve and refractive index. In this case, the device according to the invention measures deviation from the model phase element only.

During measurement, signal from the low-coherence light source is directed to the fiber optic coupler, then from the optical fibers comprising the coupler, the signal passes to collimators. After leaving the collimator, light is directed to a lens in the measurement arm, after which it is directed to a collimator. After leaving the collimator, it reaches a collimator in the second arm, the position of which depends on the shift of the motorized linear stage. Signals from collimators are directed to a coupler, where they interfere. Signal from the fiber optic coupler is directed to a detector.

When a second, coherent light source is applied apart from the low-coherence light source, signal from the low-coherence light source is directed to a fiber optic coupler, then from the optical fibers comprising the coupler, the signal passes to collimators. After leaving the collimator, light is directed to a lens (5) in the measurement arm, after which it is directed to a collimator. After leaving the collimator, it reaches a collimator in the second arm, the position of which depends on the shift of the motorized linear stage. Signals from collimators are directed to a coupler, where they interfere. Signal from the fiber optic coupler is directed to a detector. On the other side of the system, signal from the coherent light source is directed to one of the optical fibers comprising the fiber optic coupler, from which the signal produced by the low-coherence light source emerges, and to which a detector is not connected, and then from the optical fibers comprising the coupler, the signal passes to collimators. After leaving the collimator, light is directed to a lens in the measurement arm, after which it is directed to a collimator. After leaving the collimator, it reaches a collimator in the second arm, the position of which depends on the shift of the motorized linear stage. Signals from collimators are directed to a coupler, where they interfere. Signal from the fiber optic coupler is directed to a detector. Thanks to the occurrence of a second light source (coherent), it is possible to increase the precision of motorized linear stage position measurement.

When applying a model phase element placed in the reference arm, signal from the low-coherence light source is directed to a fiber optic coupler, then from the optical fibers comprising the coupler, the signal passes to collimators. After leaving the collimator, light is directed to a lens in the measurement arm, after which it is directed to a collimator. After leaving the collimator, it reaches a model lens, and then a collimator in the second arm, the position of which depends on the shift of the motorized linear stage. Signals from collimators are directed to a coupler, where they interfere. Signal from the fiber optic coupler is directed to a detector.

When measuring the curve of a phase element, signal from the low-coherence light source is directed to a fiber optic coupler, then from the optical fibers comprising the coupler, the signal passes to collimators. After leaving the collimator, light is directed to a plano-convex lens, in the measurement arm, after which is directed to a collimator. The lens (5.3) is mounted in a system that enables its movement along axes X and Y. After leaving the collimator, light reaches a collimator in the second arm, the position of which depends on the shift of the motorized linear stage. Signals from collimators are directed to a coupler, where they interfere. Signal from the fiber optic coupler is directed to a detector.

In the case of refractive index measurements in the lens, signal from the low-coherence light source is directed to a fiber optic coupler, then from the optical fibers comprising the coupler, the signal passes to collimators. After leaving the collimator, light is directed to a plane-parallel plate in the measurement arm, after which it is directed to a collimator. The plate is mounted in a configuration that enables its rotation at a preset angle. After leaving the collimator, light reaches a collimator in the second arm, the position of which depends on the shift of the motorized linear stage. Signals from collimators are directed to a coupler, where they interfere. Signal from the coupler is directed to a detector.

When performing measurement with collimators mounted in one arm only—the measurement arm—signal from the low-coherence light source is directed to a fiber optic coupler, then from the optical fibers comprising the fiber optic coupler, the signal passes to a collimator. After leaving the collimator, light is directed to a lens in the measurement arm, the position of which depends on the shift of the motorized linear stage. After leaving the optical fiber comprising the fiber optic coupler, light is directly connected to an optical fiber comprising the second fiber optic coupler. Signals from the measuring and reference arm are directed to a fiber optic coupler, where they interfere. Signal from the fiber optic coupler is directed to a detector.

When executing a system in the reflective configuration, signal from the low-coherence light source is directed to a fiber optic coupler, then from the optical fibers comprising the fiber optic coupler, the signal passes to a collimator. After leaving the collimator, light is directed to a lens in the measurement arm, after which it is reflected by a mirror and is directed by a collimator back to the fiber optic coupler and the detector. The light directed to the collimator is directed to a mirror, the position of which depends on the position of the motorized linear stage. After leaving the fiber optic coupler, light is transported to the detector.

Due to high precision of refractive index defined in the available catalogs, we can determine the thickness of the phase element with high accuracy.

The device according to the invention was presented in a figure, in which

FIG. 1 presents the invention in its basic version, in which signal from the low-coherent light source (1.1) is directed to a fiber optic coupler (2.1), then from optical fibers comprising the fiber optic coupler, signal passes to collimators (3.1) and (4.1).

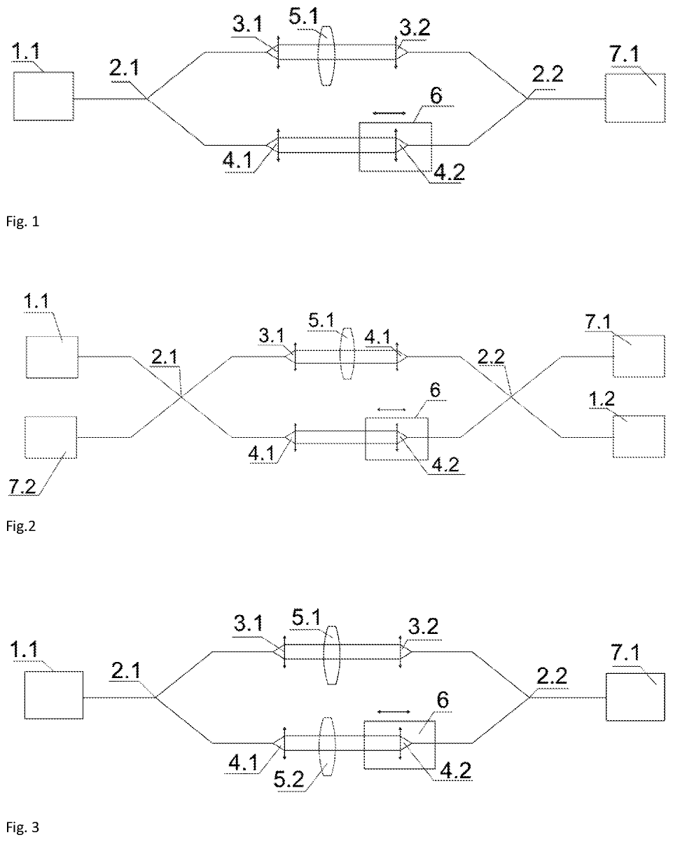

FIG. 2 presents the invention applying coherent and low-coherence light sources,

FIG. 3 presents the invention in a variant used for measurements applying model phase element,

FIG. 4 presents the invention in a configuration for measuring the curve of the phase element,

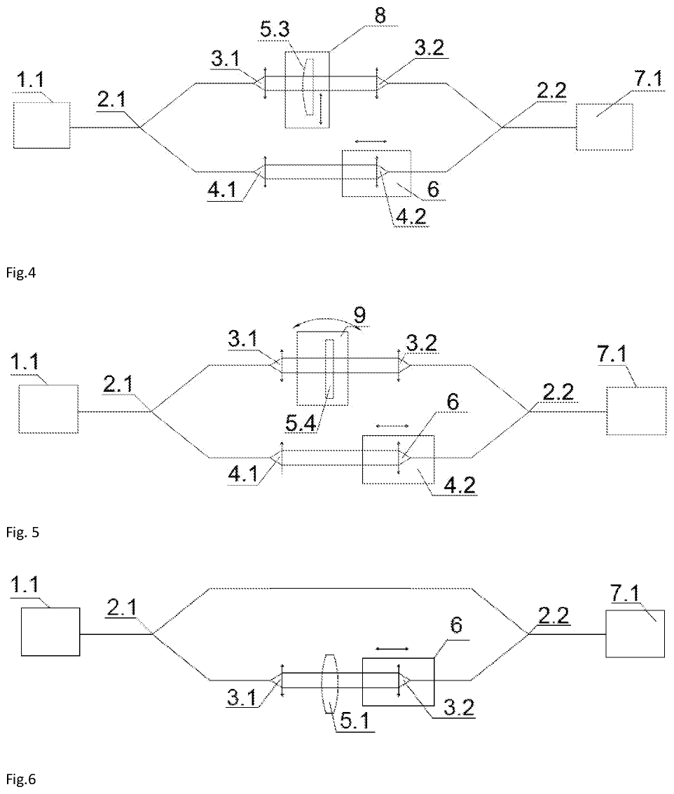

FIG. 5 presents a beneficial embodiment of the invention, used for measuring the refractive index of plane-parallel plates, in which data for two various plate inclinations are collected,

FIG. 6 presents a beneficial embodiment of the invention in the so-called reduced version,

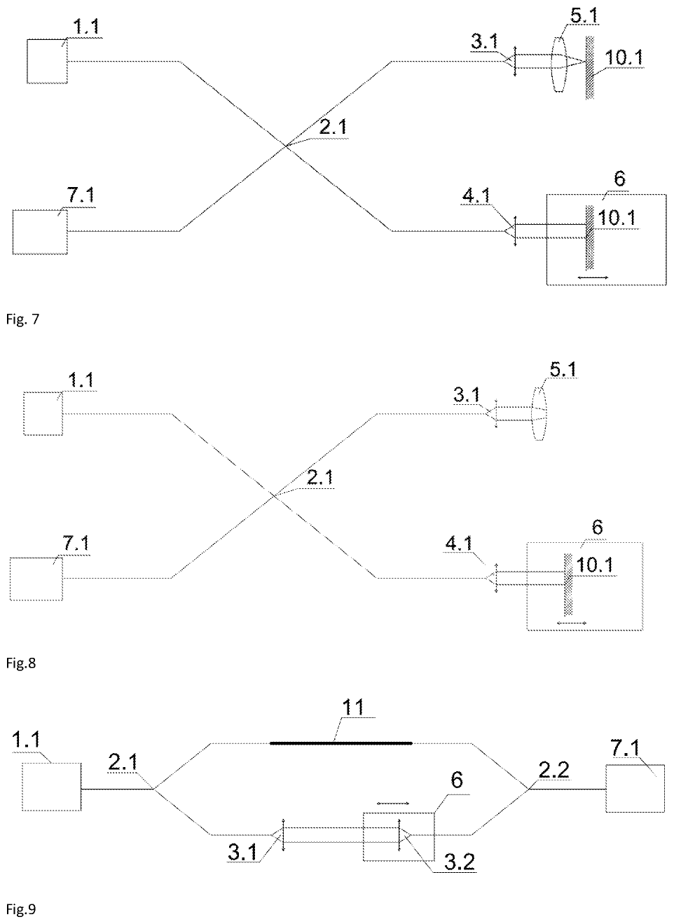

FIG. 7 presents a beneficial embodiment of the invention in a version applying reflective configuration basing on mirror reflections,

FIG. 8 presents another beneficial embodiment of the invention in a version applying reflective configuration basing on reflections from the surface of the phase element,

FIG. 9 presents a beneficial embodiment of the invention in a version for measuring the dispersion of optical fibers with high absolute dispersion values.

### EXAMPLE 1

A device for measuring the parameters of phase elements and optical fiber dispersion comprising: a low-coherence light source, a detector—photodiode, two fiber optic fiber optic couplers, a motorized linear stage, four collimators.

The measurement arm according to the invention comprises: optical fiber comprising an input fiber optic coupler, a collimator located in the end of the optical fiber comprising the input fiber optic coupler, free space, in which the phase element—a lens is mounted in a handle for the duration of measurement, a collimator located in the beginning of optical fiber comprising an output fiber optic coupler, and optical fiber comprising an output fiber optic coupler.

The reference arm of the device according to the invention comprises: optical fiber comprising an input fiber optic coupler, a collimator located in the end of the optical fiber comprising the input fiber optic coupler, free space, in which the phase element—a lens is mounted in a handle for the duration of measurement, a collimator located in the beginning of optical fiber comprising an output fiber optic coupler, and optical fiber comprising an output fiber optic coupler.

The length of the arms is divided into length in the optical fiber and length in the free space. The length of the arm in the optical fiber is standard, as listed in catalogue solutions applied in marketed fiber optic couplers and equals 1 m. The length of the arms in free space is 150 mm.

The light source is connected to the input fiber optic coupler whose optical fibers comprising a part of the measurement arm and reference arm are terminated with collimators, one of which is connected to a motorized linear stage, and a fiber optic coupler connected to a detector is connected to the other side of the measuring and reference arms. At the stage of measurement, a measured phase element—measured lens—is mounted in the free space of the measurement arm.

The method of measuring the parameters of the phase element and the dispersion of optical fibers, applying the device according to the invention is two-staged, wherein the first stage assumes the calibration of the device according to the invention, and the second stage is the proper measurement.

During calibration of the device according to the invention, light from the low-coherence light source (1.1) is directed to the fiber optic coupler (2.1), where it is separated into two arms: measuring and reference. Whereas, there are no phase elements in the free space of the measurement and reference arms.

Further on, the motorized linear stage (6) moves, registering information on its position until zero difference of optical paths between particular fiber optic coupler arms is obtained through an analysis of data from the detector and motorized linear stage positions. Interference takes place in the fiber optic coupler (2.2), after passing through the collimators (3.2) and (4.2), and interferogram is collected as the time function, which translates into motorized linear stage movement. Interferogram is collected by the photodetector, in particular by the photodiode.

After the device is calibrated, the system proceeds to proper measurement, in which a phase element, particularly a lens intended for measurement, is inserted in the measurement arm of the device according to the invention, between the collimators (3.1) and (3.2). Further on, sliding the motorized linear stage, the position producing zero optical path difference is determined. Basing on differential positions of the motorized linear stage for interferogram contrast maximums in the calibration measurement and in the proper measurement with the phase element, and having the refractive index of glass, from which the phase element was made, the thickness of the phase element, particularly the lens, is determined.

Signal from the low-coherence light source (1.1) is directed to the fiber optic coupler (2.1), then from the optical fibers comprising the fiber optic coupler, the signal passes to collimators (3.1) and (4.1). After leaving the collimator (3.1), light is directed to a phase element—lens (5.1) in the measurement arm, after which it is directed to a collimator (3.2). After leaving the collimator (4.1), it reaches a collimator (4.2) in the second arm, the position of which depends on the shift of the motorized linear stage (6). Signals from collimators (3.2) and (4.2) are directed to a fiber optic coupler (2.2), where they interfere. Signal from the fiber optic coupler is directed to a detector (7.1).

Due to high precision of refractive index defined in the available catalogs refractive index, we can determine the thickness of the phase element with high accuracy.

### EXAMPLE 2

A device for measuring the parameters of phase elements and optical fiber dispersion comprising: a low-coherence and coherent light source, two detectors in the form of photodiodes, two fiber optic couplers, a motorized linear stage, four collimators.

The measurement arm according to the invention comprises: optical fiber comprising an input fiber optic coupler, a collimator located in the end of the optical fiber comprising the input fiber optic coupler, free space, in which the phase element—a lens is mounted in a handle for the duration of measurement, a collimator located in the beginning of optical fiber comprising an output fiber optic coupler, and optical fiber comprising an output fiber optic coupler.

The reference arm of the device according to the invention comprises: optical fiber comprising an input fiber optic coupler, a collimator located in the end of the optical fiber comprising the input fiber optic coupler, free space, a collimator located in the beginning of optical fiber comprising an output fiber optic coupler mounted on a motorized linear stage, and optical fiber comprising an output fiber optic coupler.

The length of the arms is divided into length in the optical fiber and length in the free space. The length of the arm in the optical fiber is standard, as listed in catalogue solutions applied in marketed fiber optic couplers and equals 1 m. The length of the arms in free space is 150 mm. Fiber optic couplers are fabricated from standard single-mode optical fibers.

The coherent light source and the detector are connected to the input fiber optic coupler whose optical fibers comprising a part of the measurement arm and reference arm are terminated with collimators, one of which is connected to a motorized linear stage, and the input fiber optic coupler connected to a second detector and the low-coherence light source is connected to the other side of the measurement and reference arms.

In the case of the coherent light source, the coherence length is higher or equal to the range of movement of the motorized linear stage.

The method of measuring the parameters of the phase element and the dispersion of optical fibers, applying the device according to the invention is two-staged, wherein the first stage assumes the calibration of the device according to the invention, and the second stage is the proper measurement.

During calibration of the device according to the invention, light from the low-coherence (1.1) and coherent (1.2) light source is directed to the fiber optic couplers (2.1) and (2.2), where it is separated into two arms: measurement and reference. Whereas, there are no phase elements in the free space of the measuring and reference arms.

The motorized linear stage moves, which causes interferogram to be registered for each of the sources. Further on, the motorized linear stage moves, recording information on its position until zero difference of optical paths between particular fiber optic coupler arms is read with the use of detectors. Interference takes place both fiber optic couplers, whereas one of them supports interference from the coherent source, and the second—from the low-coherence source. Interferograms are collected by photodetectors, in particular by photodiodes.

After the device is calibrated, the system proceeds to proper measurement, in which a phase element, particularly a lens intended for measurement, is inserted in the measurement arm of the device according to the invention, between the collimators (3.1) and (3.2). Further on, sliding the motorized linear stage, the position producing zero optical path difference is determined. Basing on differential positions of the motorized linear stage for interferogram contrast maximums in the calibration measurement and in the proper measurement with the phase element, and having the refractive index for glass, from which the phase element was made, the thickness of the phase element, particularly the lens, is determined.

Signal from the low-coherence light source (1.1) is directed to the fiber optic coupler (2.1), then from the optical fibers comprising the fiber optic coupler, the signal passes to collimators (3.1) and (4.1). After leaving the collimator (3.1), light is directed to a phase element—lens (5.1) in the measurement arm, after which it is directed to a collimator (3.2). After leaving the collimator (4.1), it reaches a collimator (4.2) in the second arm, the position of which depends on the shift of the motorized linear stage (6). Signals from collimators (3.2) and (4.2) are directed to a fiber optic coupler (2.2), where they interfere. Signal from the fiber optic coupler is directed to a detector (7.1). On the other side of the system, signal from the coherent light source (1.2) is directed to the fiber optic coupler (2.2), then from the optical fibers comprising the fiber optic coupler, the signal passes to collimators (3.2) and (4.2). After leaving the collimator (3.2), light is directed to a phase element—lens (5.1) in the measurement arm, after which it is directed to a collimator (3.2). After leaving the collimator (4.2), it reaches a collimator (4.1) in the second arm, the position of which depends on the shift of the motorized linear stage (6). Signals from collimators (3.1) and (4.1) are directed to a fiber optic coupler (2.1), where they interfere. Signal from the fiber optic coupler is directed to a detector (7.2). Thanks to the occurrence of a second light source (coherent), it is possible to increase the precision of measurement of the motorized linear stage position.

Due to high precision of refractive index defined in the available catalogs refractive index, we can determine the thickness of the phase element with high accuracy.

### EXAMPLE 3

A device for measuring the parameters of phase elements and optical fiber dispersion comprising: a low-coherence light source, a detector—photodiode, two fiber optic couplers, a motorized linear stage, four collimators. As part of measurement, the specification of the measured phase element is determined on the basis of a model phase element—a model lens with familiar optical parameters and dimensions.

The measurement arm according to the invention comprises: optical fiber comprising an input fiber optic coupler, a collimator located in the end of the optical fiber comprising the input fiber optic coupler, free space, in which the phase element—a lens is mounted in a handle for the duration of measurement, a collimator located in the beginning of optical fiber comprising an output fiber optic coupler, and optical fiber comprising an output fiber optic coupler.

The reference arm of the device according to the invention comprises: optical fiber comprising an input fiber optic coupler, a collimator located in the end of the optical fiber comprising the input fiber optic coupler, free space, in which the model phase element—a model lens is mounted in a handle for the duration of proper measurement, a collimator located in the beginning of optical fiber comprising an output fiber optic coupler mounted on a motorized linear stage, and optical fiber comprising an output fiber optic coupler.

The length of the arms is divided into length in the optical fiber and length in the free space. The length of the arm in the optical fiber is standard, as listed in catalogue solutions applied in marketed fiber optic couplers and equals 1 m. The length of the arms in free space is 150 mm.

The light source is connected to the input fiber optic coupler whose optical fibers comprising a part of the measurement arm and reference arm are terminated with collimators, one of which is connected to a motorized linear stage, and a fiber optic coupler connected to a detector is connected to the other side of the measuring and reference arms. At the stage of measurement, a measured phase element—measurement lens—is mounted in the free space of the measurement arm, and a model phase element—model lens is mounted in the reference arm. The model phase element is mounted on a motorized linear stage.

The method of measuring the parameters of the phase element and the dispersion of optical fibers, applying the device according to the invention is two-staged, wherein the first stage assumes the calibration of the device according to the invention, and the second stage is the proper measurement.

During calibration of the device according to the invention, light from the low-coherence light source (1.1) is directed to the fiber optic coupler (2.1), where it is separated into two arms: measuring and reference. Whereas, there are no phase elements in the free space of the both arms.

Further on, the motorized linear stage (6) moves, recording information on its position until zero difference of optical paths between particular fiber optic coupler arms is read using a detector. Interference takes place in the fiber optic coupler (2.2), after passing through the collimators (3.2) and (4.2), and interferogram is collected as the time function, which translates into motorized linear stage movement. Interferogram is collected by the photodetector, in particular by the photodiode.

After the device is calibrated, the system proceeds to proper measurement, in which a phase element, particularly a lens intended for measurement, is inserted in the measurement arm of the device according to the invention, between the collimators (3.1) and (3.2). In addition, a model phase element consisting in a model lens with familiar parameters is placed between the collimators in the reference arm (4.1) and (4.2). Further on, sliding the motorized linear stage, the position producing zero optical path difference is determined. Basing on differential positions of the motorized linear stage for interferogram contrast maximums in the calibration measurement and in the proper measurement with the phase element, and having the refractive index for glass, from which the phase element was made, the thickness of the phase element, particularly the lens, is determined.

Signal from the low-coherence light source (1.1) is directed to the fiber optic coupler (2.1), then from the optical fibers comprising the fiber optic coupler, the signal passes to collimators (3.1) and (4.1). After leaving the collimator (3.1), light is directed to a phase element—lens (5.1) in the measurement arm, after which it is directed to a collimator (3.2). After leaving the collimator (4.1), it reaches a model lens (5.2) and then a collimator (4.2) in the second arm, the position of which depends on the shift of the motorized linear stage (6). Signals from collimators (3.2) and (4.2) are directed to a fiber optic coupler (2.2), where they interfere. Signal from the fiber optic coupler is directed to a detector (7.1).

Due to high precision of refractive index defined in the available catalogs refractive index, we can determine the thickness of the phase element with considerable accuracy.

### EXAMPLE 4

A device for measuring the parameters of phase elements and optical fiber dispersion comprising: a low-coherence light source, a detector—photodiode, two fiber optic couplers, a motorized linear stage, one system allowing for movement along axes X and Y, four collimators. As part of measurement, the specification of the measured phase element, flat on the one side, is determined when the phase element is placed in a system enabling its movement along axes X and Y.

The measurement arm according to the invention comprises: optical fiber comprising an input fiber optic coupler, a collimator located in the end of the optical fiber comprising the input fiber optic coupler, free space, in which the phase element—a lens is mounted in a handle that enables its movement along axes X and Y for the duration of measurement, a collimator located in the beginning of optical fiber comprising an output fiber optic coupler, and optical fiber comprising an output fiber optic coupler.

The reference arm of the device according to the invention comprises: optical fiber comprising an input fiber optic coupler, a collimator located in the end of the optical fiber comprising the input fiber optic coupler, free space, in which the model phase element—a model lens is mounted in a handle for the duration of proper measurement, a collimator located in the beginning of optical fiber comprising an output fiber optic coupler mounted on a motorized linear stage, and optical fiber comprising an output fiber optic coupler.

The length of the arms is divided into length in the optical fiber and length in the free space. The length of the arm in the optical fiber is standard, as listed in catalogue solutions applied in marketed fiber optic couplers and equals 1 m. The length of the arms in free space is 150 mm.

The light source is connected to the input fiber optic coupler whose optical fibers comprising a part of the measurement arm and reference arm are terminated with collimators, one of which is connected to a motorized linear stage, and a fiber optic coupler connected to a detector is connected to the other side of the measuring and reference arms. At the stage of measurement, a measured phase element—flat on the one side and placed on a motorized linear stage—is mounted in the measuring optical fiber area.

The method of measuring the parameters of the phase element and the dispersion of optical fibers, applying the device according to the invention is two-staged, wherein the first stage assumes the calibration of the device according to the invention, and the second stage is the proper measurement.

During calibration of the device according to the invention, light from the low-coherence light source (1.1) is directed to the fiber optic coupler (2.1), where it is separated into two arms: measuring and reference. Whereas, there are no phase elements in the free space of the both arms.

Further on, the motorized linear stage (6) moves, recording information on its position until zero difference of optical paths between particular fiber optic coupler arms is read using a detector. Interference takes place in the fiber optic coupler (2.2), after passing through the collimators (3.2) and (4.2), and interferogram is collected as the time function, which translates into motorized linear stage movement. Interferogram is collected by the photodetector, in particular by the photodiode.

After the device is calibrated, the system proceeds to proper measurement, in which a phase element, particularly a lens intended for measurement, is inserted in the measurement arm of the device according to the invention, between the collimators (3.1) and (3.2). Further on, sliding the motorized linear stages, the position producing zero optical path difference is determined. Whereas measurement is conducted in several spots, sliding the measured phase element. Basing on differential positions of the motorized linear stage for interferogram contrast maximums in the calibration measurement and in the proper measurement with the phase element, and having the refractive index for glass, from which the phase element was made, the thickness of the phase element, particularly the lens, is determined.

Signal from the low-coherence light source (1.1) is directed to the fiber optic coupler (2.1), then from the optical fibers comprising the fiber optic coupler, the signal passes to collimators (3.1) and (4.1). After leaving the collimator (3.1), light is directed to a phase element—flat on the one side (5.3) in the measurement arm, after which it is directed to a collimator (3.2). The flat measured phase element (5.3) is mounted in a system enabling its movement along axes X and Y (8). After leaving the collimator (4.1), light reaches a collimator (4.2) in the second arm, the position of which depends on the shift of the motorized linear stage (6). Signals from collimators (3.2) and (4.2) are directed to a fiber optic coupler (2.2), where they interfere. Signal from the fiber optic coupler is directed to a detector (7.1).

Due to high precision of refractive index defined in the available catalogs refractive index, we can determine the thickness of the phase element with considerable accuracy.

### EXAMPLE 5

A device for measuring the parameters of phase elements and optical fiber dispersion comprising: a low-coherence light source, a detector—photodiode, two fiber optic couplers, a motorized linear stage, four collimators. As part of measurement, the specification of the measured phase element mounted on one of the motorized linear stages.

The measurement arm according to the invention comprises: optical fiber comprising an input coupler, a collimator located in the end of the optical fiber comprising the input fiber optic coupler, free space, in which the phase element—a plane-parallel lens is mounted in a handle for the duration of measurement, a collimator located in the beginning of optical fiber comprising an output fiber optic coupler, and optical fiber comprising an output fiber optic coupler.

The reference arm of the device according to the invention comprises: optical fiber comprising an input fiber optic coupler, a collimator located in the end of the optical fiber comprising the input fiber optic coupler, free space, a collimator located in the beginning of optical fiber comprising an output fiber optic coupler mounted on a motorized linear stage, and optical fiber comprising an output fiber optic coupler.

The length of the arms is divided into length in the optical fiber and length in the free space. The length of the arm in the optical fiber is standard, as listed in catalogue solutions applied in marketed fiber optic couplers and equals 1 m. The length of the arms in free space is 150 mm. Fiber optic couplers are fabricated out of standard single-mode optical fibers.

The light source is connected to the input fiber optic coupler whose optical fibers comprising a part of the measurement arm and reference arm are terminated with collimators, one of which is connected to a motorized linear stage, and a fiber optic coupler connected to a detector is connected to the other side of the measuring and reference arms. At the stage of measurement, a measured phase element—a plane-parallel plate placed on a motorized linear stage—is mounted in the measuring optical fiber area.

The method of measuring the parameters of the phase element and the dispersion of optical fibers, applying the device according to the invention is two-staged, wherein the first stage assumes the calibration of the device according to the invention, and the second stage is the proper measurement.

During calibration of the device according to the invention, light from the low-coherence light source (1.1) is directed to the fiber optic coupler (2.1), where it is separated into two arms: measuring and reference. Whereas, there are no phase elements in the free space of the the reference and measurement arms.

Further on, the motorized linear stage (6) moves, recording information on its position until zero difference of optical paths between particular fiber optic coupler arms is read using a detector. Interference takes place in the fiber optic coupler (2.2), after passing through the collimators (3.2) and (4.2), and interferogram is collected as the time function, which translates into motorized linear stage movement. Interferogram is collected by the photodetector, in particular by the photodiode.

After the device is calibrated, the system proceeds to proper measurement, in which a phase element—a plane-parallel plate intended for measurement, is inserted in the measurement arm of the device according to the invention, between the collimators (3.1) and (3.2). Further on, sliding the motorized linear stages, the position producing zero optical path difference is determined. Whereas measurement is conducted in a manner that the measurement plate is rotated at least twice by familiar angles. Basing on differential positions of the motorized linear stage for interferogram contrast maximums in the calibration measurement and in the proper measurement with the phase element and the knowledge of rotation angles, the refractive index for the phase element is determined.

Signal from the low-coherence light source (1.1) is directed to the fiber optic coupler (2.1), then from the optical fibers comprising the fiber optic coupler, the signal passes to collimators (3.1) and (4.1). After leaving the collimator (3.1), light is directed to a plate (5.4) in the measurement arm, after which it is directed to a collimator (3.2). The plate (5.4) is mounted in a system enabling its rotation by a present angle (9). After leaving the collimator (4.1), light reaches a collimator (4.2) in the second arm, the position of which depends on the shift of the motorized linear stage (6). Signals from collimators (3.2) and (4.2) are directed to a fiber optic coupler (2.2), where they interfere. Signal from the fiber optic coupler is directed to a detector (7.1).

### EXAMPLE 6

A device for measuring the parameters of phase elements and optical fiber dispersion comprising: a low-coherence light source, a detector—photodiode, two fiber optic couplers, a motorized linear stage, two collimators. As part of measurement, the specification of the measured phase element mounted on a handle.

The reference arm according to the invention comprises: optical fiber comprising an input fiber optic coupler, a collimator located in the end of the optical fiber comprising the input fiber optic coupler, connected to optical fiber comprising an output fiber optic coupler.

The measurement arm of the device according to the invention comprises: optical fiber comprising an input fiber optic coupler, a collimator located in the end of the optical fiber comprising the input fiber optic coupler, free space, in which a lens mounted on a handle is located, a collimator located in the beginning of optical fiber comprising an output fiber optic coupler mounted on a motorized linear stage, and optical fiber comprising an output fiber optic coupler.

The length of the arms is divided into length in the optical fiber and length in the free space. The length of the arm in the optical fiber is standard, as listed in catalogue solutions applied in marketed fiber optic couplers and equals 1 m. The length of the arms in free space is 150 mm. Fiber optic couplers are fabricated out of standard single-mode optical fibers.

At the stage of measurement, a measured phase element—a measured lens—is mounted in the measuring optical fiber area, and the collimator is mounted on the motorized linear stage.

The method of measuring the parameters of the phase element and the dispersion of optical fibers, applying the device according to the invention is two-staged, wherein the first stage assumes the calibration of the device according to the invention, and the second stage is the proper measurement.

During calibration of the device according to the invention, light from the low-coherence light source (1.1) is directed to the fiber optic coupler (2.1), where it is separated into two arms: measuring and reference. Whereas, there are no phase elements in the free space of the measurement arm.

Further on, the motorized linear stage (6) moves, registering information on its position until zero difference of optical paths between particular fiber optic coupler arms is obtained. Interference takes place in the fiber optic coupler (2.2), after passing through the collimators (3.1) and (3.2), and interferogram is collected as the time function, which translates into motorized linear stage movement. Interferogram is collected by the photodetector, in particular by the photodiode.

After the device is calibrated, the system proceeds to proper measurement, in which a lens intended for measurement is inserted in the measurement arm of the device according to the invention, between the collimators (3.1) and (3.2). Further on, sliding the motorized linear stages, the position producing zero optical path difference is determined. Basing on differential positions of the motorized linear stage for interferogram contrast maximums in the calibration measurement and in the proper measurement with the phase element and the knowledge of the refractive index, the thickness of the phase element is determined.

Due to high precision of refractive index defined in the available catalogs refractive index, we can determine the thickness of the phase element with considerable accuracy.

Signal from the low-coherence light source (1.1) is directed to the fiber optic coupler (2.1), then from the optical fibers comprising the fiber optic coupler, the signal passes to the collimator (3.1). After leaving the collimator (3.1), light is directed to a lens (5.1) in the measurement arm, after which it is directed to a collimator (3.2), the position of which depends on the shift of the motorized linear stage (6). After leaving the fiber optic coupler (2.1), light is transported by the optical fiber comprising the reference arm to the second fiber optic coupler (2.2). Signals from the measuring and reference arms are directed to the fiber optic coupler (2.2), where they interfere. Signal from the fiber optic coupler is directed to a detector (7.1).

In this layout, the two collimators were resigned thus avoiding the necessity of adjusting these systems. The method is effective provided that the optical fibers comprising the system have small dispersion (which does not distort the measurement at a level which lowers the desired accuracy).

### EXAMPLE 7

In another, beneficial embodiment of the invention—in a reflective configuration of the system, as presented in FIG. 7, the device comprises: preferably a low-coherence light source, preferably a detector, preferably one fiber optic coupler, preferably two mirrors, preferably two collimators. As part of measurement, the specification of the measured phase element—a measured lens—is determined.

Whereas, compared to M-Z configuration, this embodiment of the device according to the invention enables larger impact of the phase element on the beam, since an electromagnetic wave passes through the lens twice. A need arises to increase movement precision in relation to the M-Z configuration since double passage of light through the system requires increased precision (a requirement according the Nyquist criterion), while maintaining the same range of scanning. In addition, the reflective configuration features back reflection—the same power reaches the light source and the detector (which sometimes enforces the need to apply additional optical attenuators).

Signal from the low-coherence light source (1.1) is directed to the fiber optic coupler (2.1), then from the optical fibers comprising the fiber optic coupler, the signal passes to the collimator (3.1) and collimator (4.1). After leaving the collimator (3.1), light is directed to a lens (5.1) in the measurement arm, after which it is reflected by a mirror (10.1) and through the lens (5.1) and collimator, it is directed back to the fiber optic coupler (2.1) and to the detector (7.1). The light directed to the collimator (4.1) is then directed to the mirror (10.1), the position of which depends on the shift of the motorized linear stage (6). After leaving the fiber optic coupler (2.1), light is transported to the detector (7.1).

### EXAMPLE 8

In another, beneficial embodiment of the invention—in a mirror-reflection configuration of the system, as presented in FIG. 8, the device comprises one low-coherence light source, a detector, a fiber optic coupler, a mirror, two collimators. As part of measurement, the specification of the measured phase element is determined.

The idea of measurement applying the reflective configuration does not differ from the measurement presented in example 7. The difference is the method of obtaining interference, which, in this case, occurs between signals reflected from the first and second measured surface of the phase element and the signal propagated in the reference arm: the physical operation principle remains unchanged.

Signal from the low-coherence light source (1.1) is directed to the fiber optic coupler (2.1), then from the optical fibers comprising the fiber optic coupler, the signal passes to the collimator (3.1) and collimator (4.1). After leaving the collimator (3.1), light is directed to a lens (5.1) in the measurement arm, after which it is reflected by the surface of the phase element and through the lens (5.1) and collimator, it is directed back to the fiber optic coupler (2.1) and to the detector (7.1). The light directed to the collimator (4.1) is then directed to the mirror (10.1), the position of which depends on the shift of the motorized linear stage (6). After leaving the fiber optic coupler (2.1), light is transported to the detector (7.1).

### EXAMPLE 9

In another, beneficial embodiment of the invention, intended for measuring the dispersion of optical fibers of high absolute dispersion values, as presented in FIG. 8, the device comprises one low-coherence light source, a detector, a fiber optic coupler, a mirror, two collimators. As part of measurement, the specification of the measured phase element is determined.

The primary difference between this solution and the solutions presented in examples 1-7 is that the measurement arm is replaced with an arm in the form of optical fiber with absolutely high dispersion.

In the first stage of measurement, the length of the optical fiber (11) is measured. The optical fiber is coupled with optical fibers comprising the fiber optic couplers (2.1) and (2.2). The coupling is performed by optical fiber splicing, butt coupling or otherwise. Then, interferogram is collected in the motorized linear stage (6) as the shift function, similarly to the measurements of phase element parameters. The value of dispersion of the refractive index is obtained through mathematical analysis of the generated interferogram, considering information on the length of the optical fiber (11).

Signal from the low-coherence light source (1.1) is directed to the fiber optic coupler (2.1), then from the optical fibers comprising the fiber optic coupler, the signal passes to the optical fiber with high dispersion value (11) and the collimator (3.1). After leaving the collimator (3.1), light is directed to the collimator (3.2), the position of which is regulated by the motorized linear stage (6). Signal from the optical fiber (11) and the signal leaving the collimator (3.2) interfere in the fiber optic coupler (2.2). Then, the signal is directed to the detector (7.1).

1. A device for measuring the parameters, especially thickness or refractive index or dispersion of phase elements, characterized in that the device contains: at least one fiber optic coupler (2.1), at least one low-coherence light source (1.1), serially connected to at least one input fiber optic coupler (2.1), one of whose arms constitutes a part of a reference arm, and whose second arm constitutes a part of a measurement arm of the device, and at least one motorized linear stage (6) is mounted on at least one arm of the device, and at least one of the arms of the device is connected, either directly, or through an additional output fiber optic coupler (2.2), to at least one detector (7.1; 7.2), and at least one collimator (3.1; 3.2; 4.1; 4.2) is placed in at least one of the arms of the device, at least before the measured phase element (5.1; 5.2; 5.3; 5.4; 11).

2. (canceled)

3. The device according to claim 1, characterized in that a model phase element (5.2) selected from among lenses, plane-parallel plates, optical fibers or other, is mounted in the measurement arm.

4. The device according to claim 1, characterized in that a photodiode is the detector (7.1; 7.2).

5. The device according to claim 3, characterized in that the measurement arm according to the invention contains: the optical fiber comprising the input fiber optic coupler (2.1), the first collimator (3.1) located in the end of the optical fiber comprising the input fiber optic coupler (2.1), free space, in which the phase element (5.1, 5.3, 5.4) is mounted in a handle for the duration of the measurement, the second collimator (3.2) located in the beginning of the optical fiber comprising the output fiber optic coupler (2.2), and the reference arm of the device according to the invention comprises: the optical fiber consisting: the input fiber optic coupler (2.1), the third collimator (4.1) located in the end of the optical fiber comprising the input fiber optic coupler, free space, the fourth collimator (4.2) located in the beginning of optical fiber comprising the output fiber optic coupler (2.2), whereas one of the collimators (4.1) or (4.2) or (3.1) or (3.2) is mounted on a motorized linear stage (6).

6. (canceled)

7. The device according to claim 1, characterized in that the measured phase element (5.1; 5.3; 5.4), particularly a measured lens, is placed in the free space of the measurement arm, after the first collimator (3.1), which is placed in the terminal of the optical fiber comprising the input fiber optic coupler (2.1), and before the collimator (43.2) is placed on the motorized linear stage (6), and the optical fiber comprising the input fiber optic coupler (2.1) which is not terminated with a collimator, is connected, either directly or through another optical fiber, to the optical fiber comprising the output fiber optic coupler (2.2) which is not terminated with a collimator.

8. The device according to claim 1, characterized in that the high-dispersion optical fiber (11) is connected to the optical fibers comprising the fiber optic couplers (2.1) and (2.2), and the connection is performed by fiber splicing or butt coupling or otherwise, and the second arm of the device according to the invention contains the collimator (3.1) and collimator (3.2), mutually and serially connected, and the collimator (3.2) is placed on the motorized linear stage (6), which are parallel to the high dispersion optical fiber (11) and the high-dispersion optical fiber (11) and the collimator system (3.1) and (3.2) are connected to the fiber optic coupler (2.2) connected to detector (7.1).

9. (canceled)

10. The device according to claim 1, characterized in that the device contains a second, coherent light source (1.2) is applied apart from the low-coherence light source (1.1), cross-connected to the device in relation to the first light source (1.1), and the output signal from the low-coherence light source (1.1) is directed through the input fiber optic coupler (2.1) to the reference and measurement arms, and then reaches the detector (7.1) through the connected output fiber optic coupler (2.2) and a second, coherent light source (1.2) is connected to the second optical fiber comprising the output fiber optic coupler (2.2), from which, through the measurement arm and the reference arm, signal is directed to the input fiber optic coupler (2.1) and to the second detector (7.2).

11. The device according to claim 1, characterized in that at least one light source (1.1) is connected to the input fiber optic coupler (2.1) whose optical fibers comprising a part of the measurement arm and reference arm are terminated with collimators (3.1, 4.1), one of which is connected to a motorized linear stage (6) to which a mirror (10.1) is connected, and the phase element (5.1; 5.3; 5.4) is mounted in the measurement arm area at the stage of conducting proper measurement.

12. The device according to claim 11, characterized in that an additional mirror (10.1) is placed behind the measured phase element (5.1, 5.2, 5.3, 5.4).

13. (canceled)

14. The device according to claim 1, characterized in that the motorized linear stage (6) moves along at least one axis, and the handle of the phase element (5.1; 5.2; 5.3; 5.4) moves along three axes or enables rotation around any of these axes.

15. A method of measuring the parameters especially thickness or refractive index or dispersion of the phase element (5.1; 5.2; 5.3; 5.4; 11), applying the device according to claim 1, characterized in that it is two-staged, wherein the first stage assumes the calibration of the device according to the invention, and the second stage is the proper measurement, characterized in that during calibration of the device according to the invention, light from the low-coherence light source (1.1) is directed to the fiber optic coupler (2.1), where it is separated into two arms: measuring and reference, and then the motorized linear stage (6) moves, recording information on its position until zero difference of optical paths between particular fiber optic coupler arms is obtained, interferogram is collected in time delay, by a detector (7.1; 7.2), and after the device is calibrated, the system proceeds to proper measurement, in which the phase element, is inserted in the measurement arm of the device according to the invention, after which, sliding the motorized linear stage, the position producing zero optical path difference is determined, and the selected parameter of the phase element is determined on the basis of differential positions of the motorized linear stage for the zero optical path difference in the calibration, and in the proper measurements.

16. The method according to claim 11, characterized in that the calibration and proper measurements are performed in one scanning in the reflective configuration of the device according to the invention.

17. The method according to claim 15, characterized in that during measurement signal from the low-coherence light source (1.1) is directed to the fiber optic coupler (2.1), then from the optical fibers comprising the fiber optic coupler, the signal passes to collimators (3.1) and (4.1), and after leaving the collimator (3.1) in the measurement arm, light is directed to the phase element (5.1; 5.3; 5.4), after which it is directed to a collimator (3.2), and after leaving the collimator (4.1), it illuminates a collimator (4.2) in the reference arm, where the length of the measurement arm or reference arm depends on the shift of the motorized linear stage (6), and signals from collimators (3.2 and 4.2) are directed to a fiber optic coupler (2.2), where they interfere, and signal from the fiber optic coupler is directed to a detector (7.1).

18. The method according to claim 15, characterized in that when applying a second, coherent light source apart from the low-coherence light source, signal from the low-coherence light source (1.1) is directed to the fiber optic coupler (2.1), then from the optical fibers comprising the fiber optic coupler, the signal passes to collimators (3.1) and (4.1), and after leaving the collimator (3.1), light is directed to the phase element (5.1; 5.3; 5.4) in the measurement arm, after which it is directed to a collimator (3.2), and after leaving the collimator (4.1), it reaches a collimator (4.2) in the reference arm, the position of which depends on the shift of the motorized linear stage (6), and signals from collimators (3.2 and 4.2) are directed to a fiber optic coupler (2.2), where they interfere, and signal from the fiber optic coupler is directed to a detector (7.1), while on the other side of the system, signal from the coherent light source (1.2) is directed to the fiber optic coupler (2.2), then from the optical fibers comprising the fiber optic coupler, the signal passes to collimators (3.2) and (4.2), and after leaving the collimator (3.2), light is directed to the phase element (5.1, 5.3, 5.4) in the measurement arm, after which it is directed to a collimator (3.1), and signal from the collimator (4.2) is directed to a collimator (4.1) in the reference arm, where the length of the reference optical path depends on the said shift of the motorized linear stage (6), and signals from collimators (3.1) and (4.1) are directed to a fiber optic coupler (2.1), where they interfere, and signal from the fiber optic coupler is directed to a detector (7.2).

19. The method according to claim 15, characterized in that when applying the model phase element (5.2) placed in the reference arm, signal from the low-coherence light source (1.1) is directed to the fiber optic coupler (2.1), then from the optical fibers comprising the fiber optic coupler, the signal passes to collimators (3.1) and (4.1), and after leaving the collimator (3.1), light is directed to the phase element (5.1, 5.3, 5.4) in the measurement arm, after which it is directed to a collimator (3.2), and after leaving the collimator (4.1), it reaches the model phase element (5.2) and then a collimator (4.2) in the reference arm, where the length of the reference optical path depends on the shift of the motorized linear stage (6), and signals from collimators (3.2) and (4.2) are directed to a fiber optic coupler (2.2), where they interfere, and signal from the fiber optic coupler is directed to a detector (7.1).

20. The method according to claim 15, characterized in that when measuring the curve of the phase element, signal from the low-coherence light source (1.1) is directed to the fiber optic coupler (2.1), then from the optical fibers comprising the fiber optic coupler, the signal passes to collimators (3.1) and (4.1), and after leaving the collimator (3.1), light is directed to the phase element (5.1, 5.3, 5.4) in the measurement arm, after which it is directed to a collimator (3.2), and the phase element (5.1; 5.3; 5.4) is mounted in a system enabling its movement along axes X and Y (8), and after leaving the collimator (4.1), light reaches a collimator (4.2) in the reference arm, where the length of the reference optical path depends on the shift of the motorized linear stage (6), and signals from collimators (3.2) and (4.2) are directed to a fiber optic coupler (2.2), where they interfere, and signal from the fiber optic coupler is directed to a detector (7.1).

21. The method according to claim 15, characterized in that when measuring the refractive index, signal from the low-coherence light source (1.1) is directed to the fiber optic coupler (2.1), then from the optical fibers comprising the fiber optic coupler, the signal passes to collimators (3.1) and (4.1), and after leaving the collimator (3.1), light is directed to the phase element (5.1, 5.3, 5.4) in the measurement arm, after which it is directed to a collimator (3.2), and the phase element (5.1, 5.3, 5.4) is mounted in a system enabling its rotation by a present angle (9), and after leaving the collimator (4.1), light reaches a collimator (4.2) in the reference arm, where the length of the reference optical path depends on the shift of the motorized linear stage (6), and signals from collimators (3.2) and (4.2) are directed to a fiber optic coupler (2.2), where they interfere, and signal from the fiber optic coupler is directed to a detector (7.1).

22. The method according to claim 15, characterized in that when performing measurement with collimators mounted in one arm only—in the measurement arm of the fiber optic couplers, signal from the low-coherence light source (1.1) is directed to the fiber optic coupler (2.1), then from the optical fibers comprising the fiber optic coupler, the signal passes to a collimator (3.1), and after leaving the collimator (3.1), light is directed to the phase element (5.1, 5.3, 5.4) in the measurement arm, after which it is directed to a collimator (3.2), where the length of the reference optical path depends on the shift of the motorized linear stage (6), and after leaving the fiber optic coupler (2.1), light is transported by the optical fiber comprising the reference arm to the second fiber optic coupler (2.2), and signals from the measuring and reference arms are directed to the fiber optic coupler (2.2), where they interfere, and signal from the fiber optic coupler is directed to a detector (7.1).

23. The method according to claim 16, characterized in that when applying a system in the reflective configuration, signal from the low-coherence light source (1.1) is directed to the fiber optic coupler (2.1), then from the optical fibers comprising the fiber optic coupler, the signal passes to the collimator (3.1) and the collimator (4.1), and after leaving the collimator (3.1), light is directed to the phase element (5.1, 5.3, 5.4) in the measurement arm, after which it is reflected by a mirror (10.1) and through the lens (5.1) and collimator, it is directed back to the fiber optic coupler (2.1) and to the detector (7.1), after which the light directed to the collimator (4.1) is then directed to the mirror (10.1), the position of which depends on the shift of the motorized linear stage (6), and after leaving the fiber optic coupler (2.1), light is transported to the detector (7.1).

24. The method according to claim 15, characterized in that signal from the low-coherence light source (1.1) is directed to the fiber optic coupler (2.1), then from the optical fibers comprising the fiber optic coupler, the signal passes to the collimator (3.1) and the collimator (4.1), and after leaving the collimator (3.1), light is directed to the measured phase element (5.1, 5.3, 5.4) in the measurement arm on which signal reflects and then reflected light is directed back to the collimator (3.1), to the fiber optic coupler (2.1) and to the detector (7.1), and the light directed to the collimator (4.1) is then directed to the mirror (10.1), the position of which depends on the shift of the motorized linear stage (6), and reflected signal is directed back to the collimator (4.1), the fiber optic coupler (2.1) and is transported to the detector (7.1).

25. The method according to claim 15, characterized in that when performing measurement with collimators mounted on one arm only—on the reference arm of the fiber optic couplers, signal from the low-coherence light source (1.1) is directed to the fiber optic coupler (2.1), then from the optical fibers comprising the fiber optic coupler, the signal passes to the optical fiber with high dispersion value (11) and the collimator (3.1), and after leaving the collimator (3.1), light is directed to the collimator (3.2), the position of which is regulated by the motorized linear stage (6), and signal from the optical fiber (11) and the signal leaving the collimator (3.2) interfere in the fiber optic coupler (2.2), and then is directed to the detector (7).
